(19) United States
(12) Patent Application Publication
(10) Pub. No.: US 2017/0300842 A1
(43) Pub. Date: Oct. 19, 2017

(54) SYSTEMS AND METHODS FOR IDENTIFYING UNDERREPRESENTED MERCHANT CATEGORIES WITHIN A REGION

(71) Applicant: MasterCard International Incorporated, Purchase, NY (US)

(72) Inventor: Christopher Matthew Pembery, Bourne (GB)

(21) Appl. No.: 15/098,021

(22) Filed: Apr. 13, 2016

(51) Int. Cl. G06Q 10/06; G06Q 20/10

(52) U.S. Cl. CPC G06Q 10/0639; G06Q 20/10

(57) ABSTRACT

A representation analytics (RA) computing device is described herein. The RA computing device is configured to receive transaction data associated with a plurality of transactions initiated by cardholders at a plurality of merchants located within a geographic region, the transaction data including a merchant identifier and an account identifier for each transaction. The RA computing device is also configured to determine a home location associated with each transaction, and determine a merchant location for the merchant associated with each transaction. The RA computing device is further configured to determine a transaction travel distance for each transaction, the transaction travel distance defined between the home location associated with the transaction and the merchant location of the merchant associated with the transaction, and determine an average transaction travel distance for each merchant. The RA computing device is configured to display the average transaction travel distance for each merchant within the geographic region.

### BACKGROUND

The field of the disclosure relates generally to analyzing data for determining merchant locations and merchant categories, and, more specifically, to network-based methods and systems for retrieving and analyzing transaction data to determine underrepresented merchants and/or merchant categories within a geographic region.

Industries and particular merchants therein are oftentimes interested in expanding their coverage area geographically in an attempt to reach more consumers. More particularly, merchants may be interested in obtaining coverage in geographic regions, such as states, cities, or neighborhoods, in which their industry is underrepresented. For example, grocery stores may look for regions with few other grocery stores to meet the needs of consumers there, or regions with grocery stores that do not carry particular items (e.g., regions without high-end grocery stores or stores with products catering to a particular ethnicity). It may be difficult and/or time-consuming to research and collect industry-level data that accurately and/or precisely identifies locations of the greatest consumer need. It would be desirable to have a system capable of identifying these locations based on industry, consumption, and/or geographic region.

### BRIEF DESCRIPTION

In one aspect, a representation analytics (RA) computing device is provided. The RA computing device includes a processor in communication with a memory. The RA computing device is in communication with a user computing device. The processor is programmed to receive transaction data associated with a plurality of transactions initiated by cardholders at a plurality of merchants located within a geographic region. The transaction data includes a merchant identifier and an account identifier associated with a respective cardholder for each transaction of the plurality of transactions. The processor is also programmed to determine, using the account identifiers, a home location associated with each transaction of the plurality of transactions, and determine, using the merchant identifiers, a merchant location for the respective merchant associated with each transaction of the plurality of transactions. The processor is further programmed to determine a transaction travel distance for each transaction of the plurality of transactions. The transaction travel distance is defined between the home location associated with the respective transaction and the merchant location of the merchant associated with the respective transaction. The processor is also programmed to determine an average transaction travel distance for each merchant of the plurality of merchants located with the geographic region, and display on an interactive graphical user interface of a user computing device the average transaction travel distance for each merchant within the geographic region.

In another aspect, a computer-implemented method for identifying underrepresented merchant categories within a geographic region using a representation analytics (RA) computing device is provided. The RA computing device includes a processor in communication with a memory. The method includes receiving transaction data associated with a plurality of transactions initiated by cardholders at a plurality of merchants located within a geographic region. The transaction data includes a merchant identifier and an account identifier associated with a respective cardholder for each transaction of the plurality of transactions. The method also includes determining, using the account identifiers, a home location associated with each transaction of the plurality of transactions, and determining, using the merchant identifiers, a merchant location for the respective merchant associated with each transaction of the plurality of transactions. The method further includes determining a transaction travel distance for each transaction of the plurality of transactions. The transaction travel distance is defined between the home location associated with the respective transaction and the merchant location of the merchant associated with the respective transaction. The method also includes determining an average transaction travel distance for each merchant of the plurality of merchants located with the geographic region, and displaying the average transaction travel distance for each merchant within the geographic region on an interactive graphical user interface of a user computing device in communication with the RA computing device.

In a further aspect, at least one non-transitory computer-readable storage medium having computer-executable instructions embodied thereon is provided. When executed by a representation analytics (RA) computing device including at least one processor in communication with a memory, the computer-executable instructions cause the at least one processor to receive transaction data associated with a plurality of transactions initiated by cardholders at a plurality of merchants located within a geographic region. The transaction data includes a merchant identifier and an account identifier associated with a respective cardholder for each transaction of the plurality of transactions. The computer-executable instructions also cause the at least one processor to determine, using the account identifiers, a home location associated with each transaction of the plurality of transactions, and determine, using the merchant identifiers, a merchant location for the respective merchant associated with each transaction of the plurality of transactions. The computer-executable instructions further cause the at least one processor to determine a transaction travel distance for each transaction of the plurality of transactions. The transaction travel distance is defined between the home location associated with the respective transaction and the merchant location of the merchant associated with the respective transaction. The computer-executable instructions also cause the at least one processor to determine an average transaction travel distance for each merchant of the plurality of merchants located with the geographic region, and display on an interactive graphical user interface of a user computing device the average transaction travel distance for each merchant within the geographic region.

### BRIEF DESCRIPTION OF THE DRAWINGS

FIGS. 1-6 show example embodiments of the methods and systems described herein.

FIG. 1 is a schematic block diagram of an example embodiment of a system for identifying underrepresented merchant categories within a region, in accordance with one embodiment of the present disclosure.

FIG. 2 illustrates an example configuration of a server system used in the system shown in FIG. 1.

FIG. 3 illustrates an example configuration of a client computing device used in the system shown in FIG. 1.

FIG. 4 illustrates a simplified data flow diagram for analysis of merchant representation to identify underrepresented merchant categories within a region, using the system shown in FIG. 1.

FIG. 5 is a simplified diagram of an example method for identifying underrepresented merchant categories in a geographic region using the system shown in FIG. 1.

FIG. 6 is a diagram of components of one or more example computing devices that may be used in the system shown in FIG. 1.

Although specific features of various embodiments may be shown in some drawings and not in others, this is for convenience only. Any feature of any drawing may be referenced and/or claimed in combination with any feature of any other drawing.

### DETAILED DESCRIPTION

The system and methods described herein enable a user to identify where payment transactions associated with a particular merchant type (e.g., industry) are underrepresented in a particular geographic area relative to a national average proportion of transactions for that merchant type. In particular, the system is associated with or integral to a payment processor configured to process transactions initiated by cardholders using payment cards (e.g., credit cards, debit card, prepaid cards, or other payment mechanisms associated with an account, etc.) at merchant locations within a particular geographic region. The payment processor collects transaction data associated with these transactions for further processing. The transaction data includes such elements as a transaction amount, a description of the purchase made, a merchant identifier, an account identifier (associating the transaction with a consumer or account holder), and a time and date stamp. In some implementations, the transaction data may further include additional elements such as a location identifier, which may identify where the transaction was initiated (which may be a location of the cardholder at the time of the transaction) and/or the location of the merchant.

The system includes a representation analysis (RA) computing device including a processor in communication with a memory. In the example embodiment, the RA computing device is configured to receive and process the transaction data. The RA computing device is configured to parse the transaction data for account identifier(s), and to use the account identifier(s) to determine “home locations” for the cardholders initiating the transaction. Home locations may be determined using a lookup table, for example, if home locations are represented by billing addresses. For example, the RA computing device may access a look-up table mapping account identifiers to home locations. In some embodiments, the RA computing device may not have access to precise home locations, but may instead have access to broader geographic regions including the home location, such as a zip+4 including the home location. Additionally or alternatively, a home location may be determined as a geographic center point of a locus of a plurality of transactions associated with a particular cardholder.

The RA computing device is in communication with at least one database for storing information, such as the lookup table described above and/or other data formats for determining home locations, transaction data, merchant category tables, merchant locations, and/or other information as described herein. In the example implementation, the information stored does not include any personally identifiable information (PII), but rather includes analyzed, anonymized, and/or aggregated data that does not specifically identify a consumer (e.g., a cardholder) that initiated a transaction. In other implementations, where the database may store PII, any stored PII is encrypted to prevent access to the PII by the RA computing device. Moreover, in any implementations in which PII may be collected, the consumer from which the PII may be collected is provided an opportunity to agree to or deny collection of such data.

The RA computing device is further configured to determine a distance between determined home locations and the merchant(s) at which transactions were initiated, referred to as a “transaction travel distance.” A high average transaction travel distance for a particular merchant or merchant category in a particular geographic region may indicate that such a merchant category is underrepresented in that geographic region. The RA computing device is further configured to monitor and track an average number of transactions per merchant or merchant category. In one embodiment, the RA computing device parses the transaction data for a merchant identifier for each transaction, and maintains a table tracking the number of transactions (“traffic”) associated with each merchant. The RA computing device is further configured to parse the transaction data for a transaction amount for each transaction, and may calculate an average or median transaction amount for a particular merchant. Moreover, the RA computing device is configured to access a merchant category table to identify a merchant category code for each merchant. The merchant category code defines the industry of the respective merchant (e.g., entertainment, retail, restaurant, etc.). Accordingly, the RA computing device may aggregate or otherwise combine data for a plurality of merchants having the same merchant category code (e.g., all of the retail stores in a geographic region), in order to obscure data associated with a single merchant.

In the example embodiment, the RA computing device is configured to facilitate the display of an interactive graphical user interface (UI). The UI may be displayed on a user computing device (e.g., a smartphone, laptop, desktop, tablet, etc.) of a user. The UI is configured such that the user may easily view determined transaction travel distance, traffic, and/or transaction amount for a particular merchant and/or for a particular merchant category, for example, as a graphical representation displayed on a map.

In the example embodiment, the user may search by location to find and select a geographic region (e.g., state, city, zip code, zip+4, county, neighborhood) in which the user is interested. In some embodiments, the geographic regions may be pre-defined by the RA computing device, for example, as states, counties, cities, neighborhoods, postal codes, city blocks, etc. In other embodiments, the user may define the geographic region, for example, as a freeform shape drawn on the map shown on the UI.

In one embodiment, the user may select to view average transaction travel distance, average traffic, or average transaction amount (collectively and generally “representation analytics”) for a merchant and/or merchant category within the geographic region. In one implementation, the information accessible to the user is based on a user definition. User definitions include privileged users, corporate users, and restricted users. Restricted users may only have access to merchant-category level data for a geographic region. In other words, restricted users may not be able to view more granular, merchant-level transaction travel distance, average traffic, or transaction amount. Corporate users may have access to particular merchant-level data. For example, corporate users may have access to merchant-level data for merchant locations associated therewith. As another example, corporate users may have access to all merchant-level data. Privileged users may have access to even more granular, transaction-level data, in which they can view particulars of individual transactions. However, even privileged users do not have access to cardholder PII, but rather to anonymized data.

The user may further filter the displayed information according to a date range of interest. The RA computing device facilitates display, on the UI, of the filtered data, for example, as a heat map. As transaction travel distance increases for a particular merchant category or merchant, the heat map may display darker or lighter shades (depending on the scale). Accordingly, it may be readily visible to the viewer where, in the geographic region, a particular merchant or merchant category is underrepresented. Similarly, as traffic or transaction amount increases for a particular merchant category or merchant, the heat map may display darker or lighter shades (depending on the scale). In some embodiments, the RA computing device may further facilitate display of the respective data in other formats, such as in barcharts or graphs. For example, in one embodiment, the user may select to view a barchart for the geographic region representing the number of transactions by merchant category, or the number of transactions of a certain transaction amount, or the average transaction amount by merchant category. In another embodiment, the user may select to view a barchart comparing any of those information for the geographic region to national averages (or state averages, where the geographic region is a city, etc.).

In some embodiments, the RA computing device is configured to transmit a report or recommendation to the user based on the determined representation analytics. The RA computing device may determine which merchants of the merchants in the region (and/or which merchant categories within the region) are the “least represented” and/or “most underrepresented.” The RA computing device may make such a determination as a function of average transaction travel distance. For example, the RA computing device may identify the merchants and/or merchant categories with the highest average transaction travel distance as the “least represented” merchants and/or merchant categories.

The systems and methods described herein are configured to solve problems arising in the computer network area. More specifically, the systems and method described herein are configured to solve problems arising in the transaction processing industry, in which transaction data representative of transactions is maintained and processed virtually by a small number of transaction processing networks, such that there may be limited access to such data and analytics thereof. By providing access to visual identification of underrepresented merchant categories within a geographic region, the systems and methods described herein are configured to facilitate (a) improved visualization of merchant and merchant category representation within a geographic region and/or (b) improved analytics to elucidate most efficient and consumer-friendly placement of merchant locations.

The technical effects of the systems and methods described herein can be achieved by performing at least one of the following steps: (i) receiving transaction data associated with a plurality of transactions initiated by cardholders at a plurality of merchants located within a geographic region, the transaction data including a merchant identifier and an account identifier associated with a respective cardholder for each transaction of the plurality of transactions; (ii) determining, using the account identifiers, a home location associated with each transaction of the plurality of transactions; (iii) determining, using the merchant identifiers, a merchant location for the respective merchant associated with each transaction of the plurality of transactions; (iv) determining a transaction travel distance for each transaction of the plurality of transactions, the transaction travel distance defined between the home location associated with the respective transaction and the merchant location of the merchant associated with the respective transaction; (v) determining an average transaction travel distance for each merchant of the plurality of merchants located with the geographic region; and (vi) displaying the average transaction travel distance for each merchant within the geographic region on an interactive graphical user interface of a user computing device.

The following detailed description of the embodiments of the disclosure refers to the accompanying drawings. The same reference numbers in different drawings may identify the same or similar elements. Also, the following detailed description does not limit the claims.

Described herein are computer systems such as representation analytics computing devices. As described herein, all such computer systems include a processor and a memory. However, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

As used herein, the terms “payment device,” “transaction card,” “financial transaction card,” and “payment card” refer to any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Moreover, these terms may refer to payments made directly from or using bank accounts, stored valued accounts, mobile wallets, etc., and accordingly are not limited to physical devices but rather refer generally to payment credentials. Each type of payment device can be used as a method of payment for performing a transaction. In addition, consumer card account behavior can include but is not limited to purchases, management activities (e.g., balance checking), bill payments, achievement of targets (meeting account balance goals, paying bills on time), and/or product registrations (e.g., mobile application downloads).

The systems and processes are not limited to the specific embodiments described herein. In addition, components of each system and each process can be practiced independent and separate from other components and processes described herein. Each component and process also can be used in combination with other assembly packages and processes.

The following detailed description illustrates embodiments of the disclosure by way of example and not by way of limitation. It is contemplated that the disclosure has general application to the development and sale of financial instruments associated with a financial analytics of a geographical sector.

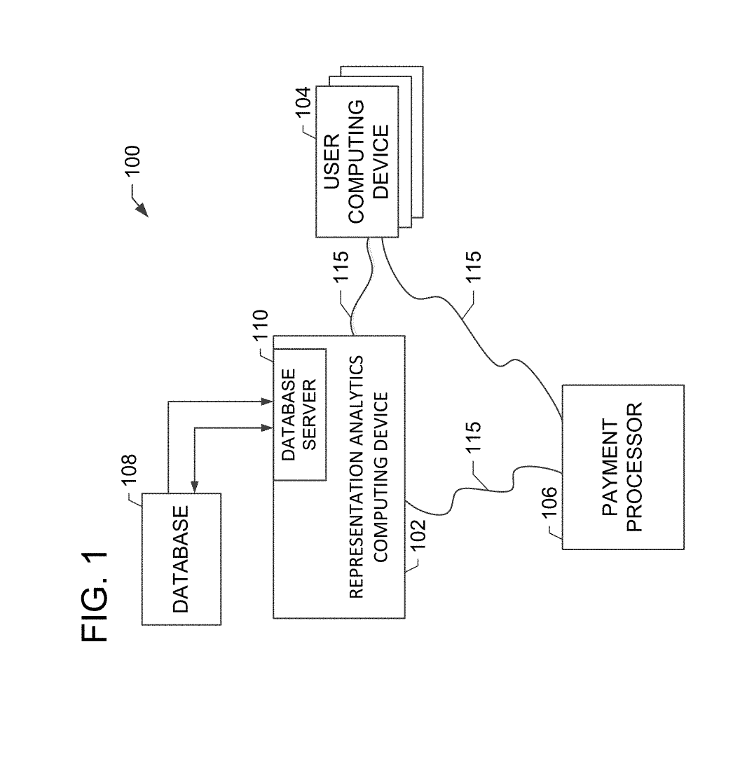

FIG. 1 is a schematic block diagram of an example embodiment of a system 100 for identifying underrepresented merchant categories within a region. More specifically, in the example embodiment, system 100 includes a representation analytics (RA) computing device 102, and a plurality of client sub-systems, also referred to as user computing devices 104, in communication with RA computing device 102. User computing devices 104 may include, for example, acquirer computing devices, merchant computing devices, cardholder computing devices, and/or computing devices associated with any other user interested in accessing the representation analysis functionality of RA computing device 102. In one embodiment, user computing devices 104 are computers including a communication interface (e.g., including a web browser or other web-access capability), such that RA computing device 102 is accessible to user computing devices 104 using the Internet and/or using network 115. User computing devices 104 are interconnected to the Internet through many interfaces including a network 115, such as a local area network (LAN) or a wide area network (WAN), dial-in-connections, cable modems, special high-speed Integrated Services Digital Network (ISDN) lines, and RDT networks. User computer devices 104 could be any device capable of interconnecting to the Internet, including a web-based phone, personal computer, server computing device, or other web-based connectable equipment. RA computing device 102 is also in communication with a payment processor 106 using network 115.

Payment processor 106 is associated with and/or integral to payment processing network (not shown). In a typical transaction card system, a financial institution called the “issuer” issues a transaction card, such as a credit card, to a consumer or cardholder, who uses the transaction card to tender payment for a purchase from a merchant. To accept payment with the transaction card, the merchant must normally establish an account with a financial institution that is part of the financial payment system. This financial institution is usually called the “merchant bank,” the “acquiring bank,” or the “acquirer.” When the cardholder tenders payment for a purchase with a transaction card, the merchant requests authorization from a merchant bank for the amount of the purchase, for example, by receiving account information associated with the cardholder and communicating the account information to the merchant bank. Using payment processor 106, the merchant will communicate with the issuer bank to determine whether the cardholder's account is in good standing and whether the purchase is covered by the cardholder's available credit line. Based on these determinations, the request for authorization will be declined or accepted. If a request for authorization is accepted, the available credit line of the cardholder's account is decreased. If the cardholder uses a debit card, the available funds in the cardholder's account will be decreased. Payment processor 106 may store the transaction card information, such as a type or category of merchant, amount of purchase, date of purchase, in a database (e.g., a database 108, described further herein).

After a purchase has been made, a clearing process occurs to transfer additional transaction data related to the purchase among the parties to the transaction. More specifically, during and/or after the clearing process, additional data, such as a time of purchase, a merchant name, a type of merchant, purchase information, account-holder account information, a type of transaction, savings information, information regarding the purchased item and/or service, and/or other suitable information, is associated with a transaction and transmitted between parties to the transaction as transaction data. Payment processor 106 is configured to process transaction data generated in association with a plurality of financial transactions as described above. Transaction data includes such elements as a transaction amount; a merchant identifier; an account identifier (associating the transaction with the cardholder); a time and date stamp; and a location identifier, which may identify where the transaction was initiated, a location of the cardholder at the time the transaction was initiated, and/or the location of the merchant (e.g., the POS device). Payment processor 106 may store the transaction data in database 108 and/or may transmit the transaction data to RA computing device 102.

A database server 110 is connected to database 108, which contains information on a variety of matters, as described below in greater detail. In one embodiment, centralized database 108 is stored on RA computing device 102. In an alternative embodiment, database 108 is stored remotely from RA computing device 102 and may be non-centralized. Database 108 may include a single database having separated sections or partitions, or may include multiple databases, each being separate from each other. Database 108 may be a database configured to store information used by RA computing device 102 including, for example, transaction data, user definitions, user input, merchant categories, merchant locations, population information, and any other information as described herein.

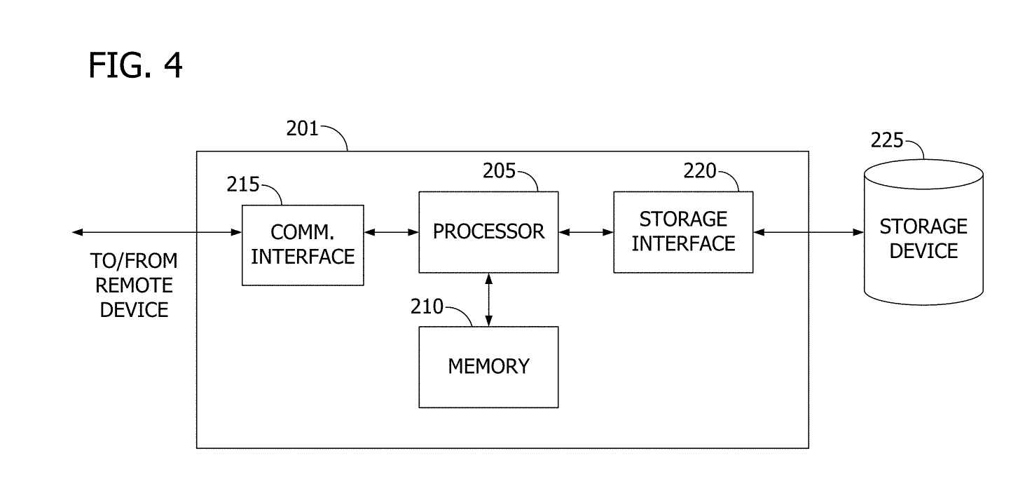

FIG. 2 illustrates an example configuration of a server system 201 such as representation analytics (RA) computing device 102, payment processor 106, and/or database server 110 (all shown in FIG. 1) used to identify an underrepresented merchant category within a region, in accordance with one example embodiment of the present disclosure. Server system 201 includes a processor 205 for executing instructions. Instructions may be stored in a memory area 210, for example. Processor 205 may include one or more processing units (e.g., in a multi-core configuration) for executing instructions. The instructions may be executed within a variety of different operating systems on the server system 201, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 205 is operatively coupled to a communication interface 215 such that server system 201 is capable of communicating with a remote device such as a user system or another server system 201. For example, communication interface 215 may receive requests (e.g., requests to provide an interactive user interface) from a user computing device 104 (shown in FIG. 1) via the Internet, as illustrated in FIG. 1.

Processor 205 may also be operatively coupled to a storage device 225. Storage device 225 is any computer-operated hardware suitable for storing and/or retrieving data. In some embodiments, storage device 225 is integrated in server system 201. For example, server system 201 may include one or more hard disk drives as storage device 225. In other embodiments, storage device 225 is external to server system 201 and may be accessed by a plurality of server systems 201. For example, storage device 225 may include multiple storage units such as hard disks or solid state disks in a redundant array of inexpensive disks (RAID) configuration. Storage device 225 may include a storage area network (SAN) and/or a network attached storage (NAS) system.

In some embodiments, processor 205 is operatively coupled to storage device 225 via a storage interface 220. Storage interface 220 is any component capable of providing processor 205 with access to storage device 225. Storage interface 220 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 205 with access to storage device 225.

Memory area 210 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

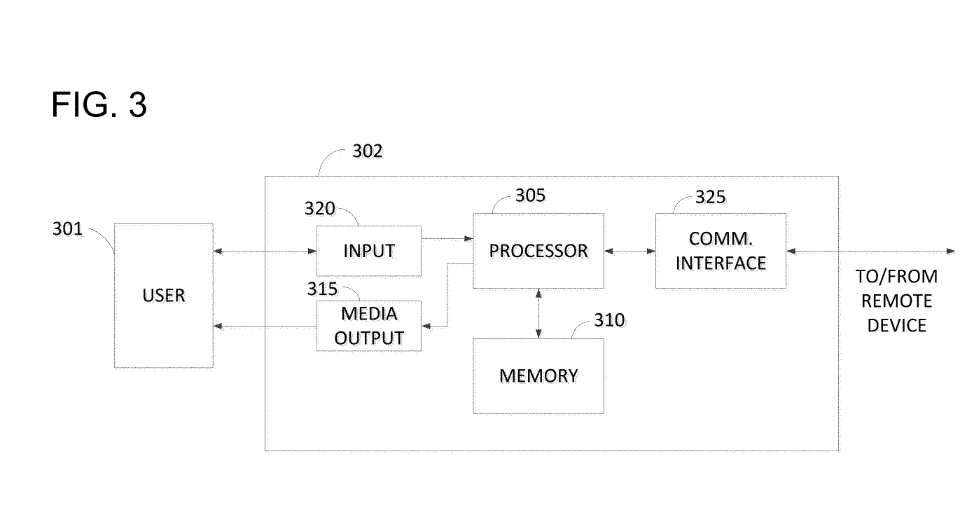

FIG. 3 illustrates an example configuration of a client computing device 302. Client computing device 302 may include, but is not limited to, client systems (“user computing devices”) 104 (shown in FIG. 1). Client computing device 302 includes a processor 305 for executing instructions. In some embodiments, executable instructions are stored in a memory area 310. Processor 305 may include one or more processing units (e.g., in a multi-core configuration). Memory area 310 is any device allowing information such as executable instructions and/or other data to be stored and retrieved. Memory area 310 may include one or more computer-readable media.

Client computing device 302 also includes at least one media output component 315 for presenting information to a user 301 (e.g., a cardholder or user associated with a merchant). Media output component 315 is any component capable of conveying information to user 301. In some embodiments, media output component 315 includes an output adapter such as a video adapter and/or an audio adapter. An output adapter is operatively coupled to processor 305 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, client computing device 302 includes an input device 320 for receiving input from user 301. Input device 320 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 315 and input device 320. Stored in memory area 310 are, for example, computer-readable instructions for providing a user interface to user 301 via media output component 315 and, optionally, receiving and processing input from input device 320.

Client computing device 301 may also include a communication interface 325, which is communicatively couplable to a remote device such as representation analytics (RA) computing device 102 (shown in FIG. 1) and/or another user computing device 104 (e.g., via a web-based application programming interface (API)). Communication interface 325 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

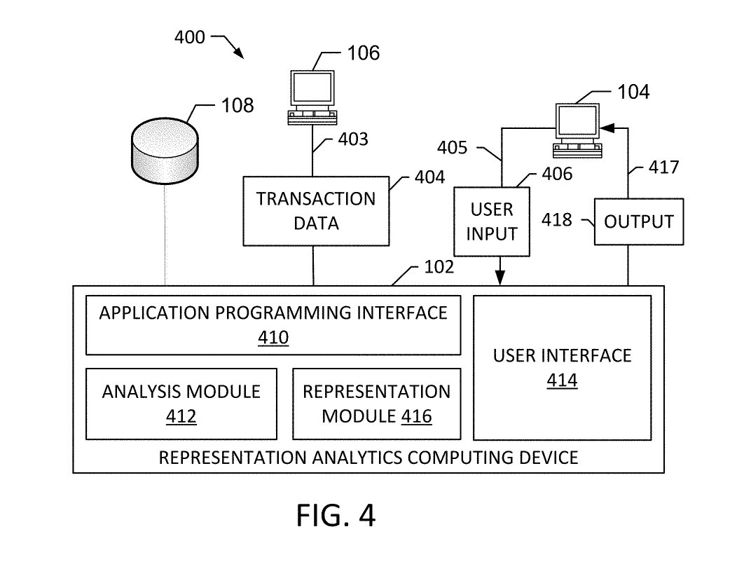

FIG. 4 illustrates a simplified data flow diagram 500 for analyzing merchant representation to identify underrepresented merchant categories within a region by system 100 (shown in FIG. 1). In particular, representation analytics (RA) computing device 102 (also shown in FIG. 1) is in communication with several other computing devices. In the illustrated embodiment, RA computing device 102 is in communication with one or more user computing devices 104, payment processor 106, and database 108 (all shown in FIG. 1).

Furthermore, RA computing device 102 includes a plurality of modules configured to implement various functions for analyzing merchant representation to identify underrepresented merchant categories within a region. In the illustrated embodiment, RA computing device includes an Application Programming Interface (API) 410, an analysis module 412, a user interface 414, and a representation module 416. API 410 is configured to facilitate access to RA computing device 102 by a plurality of other devices, namely user computing devices 104. Analysis module 412 is configured to perform various analytical functions on received input, as described further herein. User interface 414 is configured to facilitate the display of various information to a user of user computing device(s) 104. For example, user interface 414 may communicate with API 410 to facilitate display of a software program or application (“app”) with which the user of user computing device 104 may interact. Representation module 416 is configured to arrange output from analysis module 412 (e.g., representation analytics) for display through user interface 414.

In the example embodiment, RA computing device 102 receives a number of inputs. In particular, RA computing device receives a data signal 403 from payment processor 106 including transaction data 404. Transaction data 404 includes data representative of a plurality of transactions initiated by cardholders at merchants over a period of time (e.g., a month, six months, a year, etc.). Transaction data 404 includes a transaction amount, a transaction date and time stamp, and a merchant identifier for each transaction, as well as an account identifier associated with the respective cardholder that initiated each transaction. (It should be understood that the account identifiers need not be actual account numbers or other personally identifiable information (PII), but may instead include encrypted or anonymized account identifiers.) In some embodiments, transaction data 404 further includes a merchant location, such as a street address or coordinates associated with a physical location of the merchant. In other embodiments, RA computing device 102 retrieves a merchant location lookup table from database 108. The merchant location lookup table may associate merchant locations with merchant identifiers, such that RA computing device 102 may determine the merchant location of a particular merchant using the merchant identifier included within transaction data 404.

RA computing device 102 also receives an input signal 405 from a user computing device 104, input signal 405 including user input 406. User input 406 may include various information associated with a request from the user of user computing device 104 for representation analytics to be displayed. More particularly, user input 406 may include a selection of a geographic region for which the user wishes to view representation analytics. In some embodiments, the user may select from a list of pre-defined geographic regions, such as a city, county, state, neighborhood, etc. Additionally or alternatively, the user may select a user-defined region of interest. For example, in one embodiment, user interface 414 is configured to facilitate display of an interactive map at user computing device 104. The user of user computing device 104 may interact with the displayed map (e.g., via input device 320, shown in FIG. 3, such as a touchscreen or mouse) to “draw” a defined or freeform shape on the map identifying the user-defined geographic region. The shape may be a circle, square, ellipse, regular shape, and/or irregular shape. In some embodiments, the selected geographic region must include a minimum number of merchants therein. Accordingly, if the user has “drawn” or otherwise selected a geographic region with fewer than the minimum number of merchants, user interface 414 may display a prompt for the user to select a larger geographic region and/or may automatically “scale up” the selected geographic region (e.g., expand the drawn shape) until it encompasses at least the minimum number of merchants.

User input 406 may also include a selection of which representation analytic to be displayed to the user, such as average transaction travel distance, number of transactions, or average transaction amount, as described further herein. User input 406 may also include a user definition. The user definition indicates to RA computing device 102 how much information is accessible to the user of user computing device. User definitions include, in one embodiment, privileged users, corporate users, and restricted users, as described further herein.

In one embodiment, analysis module 412 uses the selected geographic region to filter and/or parse received transaction data 404. Analysis module 412 may only access, receive, and/or process transaction data 404 associated with transactions that were initiated at merchants located within the selected geographic region. Analysis module 412 is configured to determine a merchant category (also referred to herein as “merchant type” or “industry”) for each merchant within the geographic region. In some embodiments, analysis module 412 accesses a merchant category lookup table from database 108. The merchant category lookup table may associate merchants with merchant categories (e.g., using a merchant category code or other identifier). Such a lookup table may be generated using information from a third party (not shown) which collects merchant information and provides the merchant information to RA computing device 102 (and/or payment processor 106, database 108, etc.). Accordingly, analysis module 412 may aggregate or otherwise combine data for a plurality of merchants having the same merchant category code (e.g., all of the retail stores in the geographic region), in order to obscure data associated with a single merchant.

Analysis module 412 parses transaction data 404 associated with the geographic region for account identifier(s) of the cardholder(s) responsible for initiating the transactions within transaction data 404. Analysis module 412 uses account identifier(s) to determine “home locations” for those cardholders. Home locations represent a likely home or starting point for each cardholder, from which they travel to merchant(s) within the geographic region. In some embodiments, home locations are represented by billing addresses and/or broader address identifiers, such as a ZIP+4 code including the billing address of the cardholder, to obscure any PII. In such embodiments, analysis module 412 may determine home locations using a home location lookup table retrieved from database 108. For example, the home location lookup table may associate account identifiers with home locations. In cases where only a ZIP+4 code (or another broad address identifier) is available, analysis module 412 may assign the home location for the associated cardholder as a geographic center of the physical area associated with the ZIP+4 code.

Additionally or alternatively, a home location may represent a geographic center point of a locus of a plurality of transactions associated with a particular cardholder. In such embodiments, analysis module 412 may process transaction data 404 to identify a plurality of transactions sharing the same account identifier (i.e., associated with the same cardholder and/or the same account). Analysis module 412 may subsequently identify a merchant location associated with each of the plurality of transactions, and may then determine the geographic center point of the locus of the plurality of transactions.

For each transaction within transaction data 404, analysis module 412 is configured to determine a distance between each determined home location and the merchant location of the merchant at which the transaction was initiated. This distance is referred to as a “transaction travel distance.” Analysis module 412 may subsequently determine an average, weighted average, or median transaction travel distance for one or more merchants within the geographic region, for all transactions initiated at that merchant over the period of time. Moreover, analysis module 412 may determine an average transaction travel distance for a merchant category, for all transactions initiated at merchants within the merchant category over the period of time. A high average (or weighted average or median) transaction travel distance for a merchant or merchant category in the geographic region may indicate that such the merchant or merchant category is underrepresented in that geographic region.

Analysis module 412 may be further configured to track a number of transactions initiated at each merchant within the period of time. In some embodiments, analysis module 412 may maintain a table for tracking the number of transactions per merchant. Analysis module 412 may then determine an average number of transactions per merchant or merchant category for an interval of time within the period of time (e.g., for a month within a year).

In some embodiments, analysis module 412 parses transaction data 404 to identify a transaction amount for each transaction initiated at a merchant within the geographic region. Analysis module 412 may then calculate an average, weighted average, or median transaction amount for that merchant. Analysis module 412 may further calculate an average transaction amount for a merchant category using the average transaction amounts calculated for each merchant within the merchant category in the geographic region.

Analysis module 412 may be configured to determine a plurality of “least represented” and/or “most underrepresented” merchants and/or merchant categories within the selected geographic region based on the representation analytics. Analysis module 412 may identify a pre-determined number (e.g., five, ten, etc.) of merchants and/or merchant categories with the highest average transaction travel distance. Analysis module 412 may also factor number of transactions and/or average transaction amount into the determination of the most underrepresented merchants and/or merchant categories.

Moreover, analysis module 412 may be configured to determine representation analytics for additional geographic regions for comparison to the selected geographic region. For example, analysis module 412 may determine representation analytics for larger geographic regions containing the selected geographic region (e.g., a state and a nation), such that representation analytics for merchants and/or merchant categories for the selected geographic region may be compared to state or national averages.

In some embodiments, analysis module 412 is configured to identify online, phone, or otherwise “card-not-present” or virtual transactions within transaction data 404. For example, the merchant identifier associated with a transaction may indicate that the transaction was associated with an online branch of the merchant. The merchant identifier may also be associated with an only-online merchant, which may be determine using the merchant category lookup table described above (and/or using any other method for making such a determination). Analysis module 412, in certain embodiments, may be configured to discard or otherwise discount virtual transactions. In other embodiments, analysis module 412 may still associate the transaction with the merchant within a merchant category, but may identify such a transaction as a virtual transaction, such that alternative analytics may be generated. For example, analysis module 412 may be configured to calculate a number of transactions or average transaction amount for “virtual merchants” within a merchant category. Such analytics may provide a useful tool to identify a particular need for a “brick and mortar” merchant in that merchant category in the geographic region. For example, consumers may believe that it is too far to travel to a brick and mortar merchant within that merchant category, and may thus choose to make online transactions for those goods or services.

Based on user input 406, which includes a user selection of which representation analytic(s) the user of user computing device 104 wishes to view, representation module 416 arranges output from analysis module 412 for display. For example, if user input 406 indicates user selection of average transaction travel distance, representation module 416 prepares the determined average transaction travel distance for representation to the user. In the example embodiment, the selected analytic(s) are displayed as relative values. For example, the average transaction travel distance may displayed for a plurality of merchants or merchant categories within the geographic region relative to one another. As another example, the analytics may displayed for merchants or merchant categories within the geographic region relative to other geographic regions (e.g., relative to national analytics). Relative values may be arranged or formatted for display as plots, graphs, and/or charts (e.g., a barchart). Additionally or alternatively, relative values may displayed as a “heat map” overlaid on the interactive map displayed to the user. In some embodiments, a display format is selected by the user.

Representation module 416 is configured to identify what analytic(s) the user of user computing device 104 may access based on the user definition received within user input 406. Restricted users may only have access to merchant-category level analytics for a geographic region. In other words, restricted users may not be able to view more granular, merchant-level transaction travel distance, average traffic, or transaction amount. Accordingly, for restricted users, representation module 416 may only arrange or format merchant-category level analytics for display. Additionally or alternatively, user interface 414 may be configured to “lock” certain selection options or features from the user of user computer device 104 according to the user definition. For example, user interface 414 may not permit selection of merchant-level analytics for viewing by the user of user computing device 104. Corporate users may have access to particular merchant-level analytics, as well as merchant-category level analytics. For example, corporate users may have access to merchant-level data for merchant locations associated with the corporate user. For example, a particular corporate user's user definition may associate that user with Corporation A, and that user may be permitted to view all merchant-level data for Corporation A. In other embodiments, corporate users may have access to all merchant-level data. Privileged users may have access to even more granular, transaction-level analytics, as well as merchant-category and merchant-level analytics. Transaction-level analytics are representative of particulars of individual transactions (and/or small groups of transactions, such as three or five transactions). However, even privileged users do not have access to cardholder PII, but rather to anonymized data.

Furthermore, in some embodiments, representation module 416 is configured to retrieve population information from database 108. Population information may be representative of population within the selected geographic region, such as a number of people and/or a population density. Representation module 416 may be configured to display relative value of representation analytics as a function of the population information. For example, representation module 416 may be configured to determine relative values of the representation analytics “per capita” or “per thousand people”.

User interface 414 is configured to communicate the arranged or formatted analytic(s) for display at user computing device 104 (e.g., within an app or web browser). User interface 414 facilitates display of average transaction travel distance, average traffic, or average transaction amount for a merchant and/or merchant category within the geographic region, based on a user selection. Moreover, user interface 414 facilitates display of the selected analytic(s) based on the user-selected display format. For example, user interface 414 may facilitate display of the analytic(s) as a bar chart, initially, and upon user-selection of a different display format, may facilitate display of the analytic(s) as a heat map. The heat map may display darker or lighter shades or colors (depending on the scale) as the selected analytic increases or decreases. The user may select to view average transaction travel distance for merchants in the geographic region, and the heat map may readily indicate to the viewer where, in the geographic region, a particular merchant or merchant category is underrepresented. In certain embodiments, the user may select to view the analytic (e.g., as a barchart) for merchants or a merchant category within the region compared to national averages (or state averages, where the geographic region is a city, etc.).

RA computing device 102 may be configured to transmit an output signal 417 to user computing device 104, output signal 417 including output 418. Output 418 includes generated representation analytics, as described herein. Moreover, output 418 includes at least one report or recommendation to the user of user computing device 104 based on the representation analytics. For example, output 418 may include a report of the determined most underrepresented merchants and/or merchant categories within the geographic region. Accordingly, the user of user computing device 104, if associated with a particular merchant or merchant category, may use the report to make business decisions regarding placement of a new merchant location. Output 418 may include comparisons of the representation analytics for the selected geographic region with state or national averages. Output 418 may alternatively or additionally include a recommendation for placement of a particular merchant or merchant category within the selected geographic region (e.g., recommendation of placement of the most underrepresented merchant and/or merchant category within the selected geographic region).

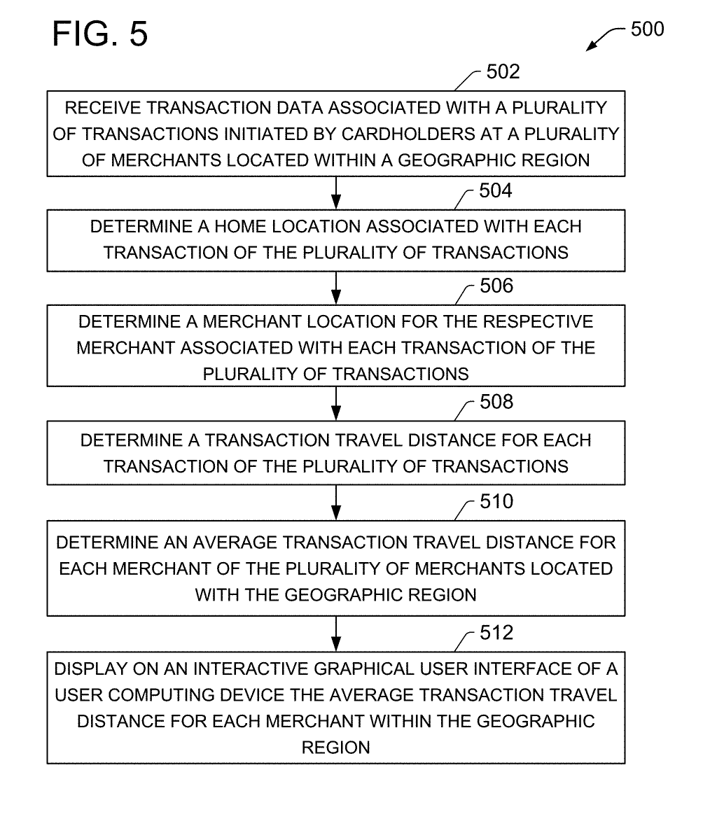

FIG. 5 is a simplified diagram of an example method 500 for identifying merchant categories underrepresented in a geographic region using system 100 (shown in FIG. 1). One or more steps of method 500 may be implemented using representation analytics (RA) computing device 102 (also shown in FIG. 1).

Method 500 includes receiving 502 transaction data (e.g., transaction data 404, shown in FIG. 4) associated with a plurality of transactions initiated by cardholders at a plurality of merchants located within a geographic region. In one embodiment, the transaction data includes a merchant identifier and an account identifier associated with a respective cardholder for each transaction of the plurality of transactions. Method 500 also includes determining 504 a home location associated with each transaction of the plurality of transactions. The home location may be determined 504 using the account identifiers in the transaction data. Method 500 further includes determining 506 a merchant location for the respective merchant associated with each transaction of the plurality of transactions. The merchant location may be determined 506 using the merchant identifiers. Additionally or alternatively, the merchant location may be determined 506 using other information in the received transaction data.

Method 500 also includes determining 508 a transaction travel distance for each transaction of the plurality of transactions. The transaction travel distance is defined between the home location associated with the respective transaction and the merchant location of the merchant associated with the respective transaction. Method 500 further includes determining 510 an average transaction travel distance for each merchant of the plurality of merchants located with the geographic region. Method 500 includes displaying 512 on an interactive graphical user interface of a user computing device (e.g., user computing device 104, shown in FIG. 1) the average transaction travel distance for each merchant within the geographic region. It should be understood that displaying 512 average transaction travel distance (or any other information) may include directly displaying and/or other facilitating display, as described herein.

Method 500 may include additional or alternative steps, including those described elsewhere herein. For example, method 500 may include steps for determining and display other representation analytics than average transaction distance, such as a number of transaction or an average transaction amount.

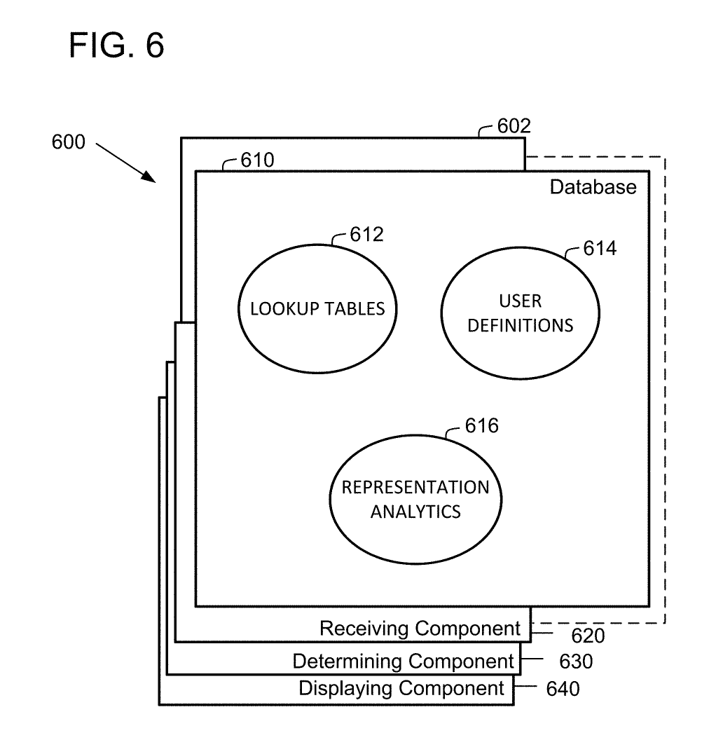

FIG. 6 is a diagram 600 of components of one or more example computing devices 602 that may be used in system 100 (shown in FIG. 1). Computing device 602 may include, for example, representation analytics (RA) computing device 102 (shown in FIG. 1). A database 610 may store information such as, for example, lookup tables 612 (such as merchant category tables, home location tables, merchant location tables, etc.), user definitions 614 (e.g., restricted, corporate, privileged, as well as the permissions associated therewith), and/or representation analytics 616 (e.g., representation analytics that have been previously generated by computing device 602 according to the processes and methods described herein). Database 610 may be similar to database 108 (shown in FIG. 1), and is coupled to several separate components within computing device 602, which perform specific tasks.

In particular, computing device 602 includes a receiving component 620 configured to receive transaction data associated with a plurality of transactions initiated by cardholders at a plurality of merchants located within a geographic region. The transaction data includes a merchant identifier and an account identifier associated with a respective cardholder for each transaction of the plurality of transactions.

Computing device 602 also includes one or more determining components 630. Determining component(s) 630 is configured to determine a home location associated with each transaction of the plurality of transactions and determine a merchant location for the respective merchant associated with each transaction of the plurality of transactions. Determining component(s) 630 may utilize various elements of the received transaction data to perform such determinations. For example, determining component(s) 630 may use account identifiers to determine the home location(s) and merchant identifiers to determine the merchant location(s). Determining component(s) 630 is further configured to determine a transaction travel distance for each transaction of the plurality of transactions. The transaction travel distance is defined between the home location associated with the respective transaction and the merchant location of the merchant associated with the respective transaction. Determining component(s) 630 is also configured to determine an average transaction travel distance for each merchant of the plurality of merchants located with the geographic region. In some embodiments, determining component(s) 630 may be configured to determine other representation analytic(s) than transaction travel distance.

Computing device 602 further includes a displaying component 640 configured to display and/or facilitate display of the average transaction travel distance for each merchant within the geographic region. In one embodiment, displaying component 640 displays the average transaction travel distance (and/or any other determined representation analytic(s)) on an interactive graphical user interface of a user computing device.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the disclosure, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A representation analytics (RA) computing device including a processor in communication with a memory, said RA computing device in communication with a user computing device, said processor programmed to:
receive transaction data associated with a plurality of transactions initiated by cardholders at a plurality of merchants located within a geographic region, the transaction data including a merchant identifier and an account identifier associated with a respective cardholder for each transaction of the plurality of transactions;
determine, using the account identifiers, a home location associated with each transaction of the plurality of transactions;
determine, using the merchant identifiers, a merchant location for the respective merchant associated with each transaction of the plurality of transactions;
determine a transaction travel distance for each transaction of the plurality of transactions, the transaction travel distance defined between the home location associated with the respective transaction and the merchant location of the merchant associated with the respective transaction;
determine an average transaction travel distance for each merchant of the plurality of merchants located with the geographic region;
display on an interactive graphical user interface of the user computing device the average transaction travel distance for each merchant within the geographic region.

2. The RA computing device of claim 1, wherein the average transaction travel distance is graphically represented on a map of the geographic region.

3. The RA computing device of claim 1, wherein said processor is further configured to receive user input of a selection of the geographic region for which to display the average transaction travel distance.

4. The RA computing device of claim 1, wherein said processor is further programmed to:
determine a merchant category of a plurality of merchant categories associated with each respective merchant of the plurality of merchants;
determine an average transaction travel distance for each merchant category of the plurality of merchant categories using the average transaction travel distance for each merchant within each merchant category of the plurality of merchant categories; and
display on the interactive graphical user interface the average transaction travel distance for each merchant category.

5. The RA computing device of claim 1, where said processor is further configured to:
determine a number of transactions initiated at each respective merchant of the plurality of merchants located within the geographic region; and
display on the interactive graphical user interface the number of transactions for each merchant relative to the other merchants of the plurality of merchants, wherein the number of transactions is represented as a barchart.

6. The RA computing device of claim 1, where said processor is further configured to:
determine an average transaction amount associated with each respective merchant of the plurality of merchants located within the geographic region; and
display on the interactive graphical user interface the average transaction amount for each merchant relative to the other merchants of the plurality of merchants, wherein the number of transactions is represented as a barchart.

7. The RA computing device of claim 1, wherein said processor is further configured to:
receive a user definition associated with the user computing device; and
determine data to be displayed on the graphical user interface based on the user definition.

8. The RA computing device of claim 1, wherein said processor is further programmed to:
identify at least one merchant of the plurality of merchants as a most underrepresented merchant; and
transmit a report of the at least one most underrepresented merchant to the user computing device.

9. A computer-implemented method for identifying underrepresented merchant categories within a geographic region using a representation analytics (RA) computing device including a processor in communication with a memory, said method comprising:
receiving transaction data associated with a plurality of transactions initiated by cardholders at a plurality of merchants located within a geographic region, the transaction data including a merchant identifier and an account identifier associated with a respective cardholder for each transaction of the plurality of transactions;
determining, using the account identifiers, a home location associated with each transaction of the plurality of transactions;
determining, using the merchant identifiers, a merchant location for the respective merchant associated with each transaction of the plurality of transactions;
determining a transaction travel distance for each transaction of the plurality of transactions, the transaction travel distance defined between the home location associated with the respective transaction and the merchant location of the merchant associated with the respective transaction;
determining an average transaction travel distance for each merchant of the plurality of merchants located with the geographic region;
displaying the average transaction travel distance for each merchant within the geographic region on an interactive graphical user interface of a user computing device in communication with the RA computing device.

10. The computer-implemented method of claim 9, wherein displaying the average transaction travel distance comprises displaying the average transaction travel distance graphically represented on a map of the geographic region.

11. The computer-implemented method of claim 9 further comprising receiving user input of a selection of the geographic region for which to display the average transaction travel distance.

12. The computer-implemented method of claim 9 further comprising:
determining a merchant category of a plurality of merchant categories associated with each respective merchant of the plurality of merchants;
determining an average transaction travel distance for each merchant category of the plurality of merchant categories using the average transaction travel distance for each merchant within each merchant category of the plurality of merchant categories; and
displaying on the interactive graphical user interface the average transaction travel distance for each merchant category.

13. The computer-implemented method of claim 9 further comprising:
determining a number of transactions initiated at each respective merchant of the plurality of merchants located within the geographic region; and
displaying on the interactive graphical user interface the number of transactions for each merchant relative to the other merchants of the plurality of merchants, wherein the number of transactions is represented as a barchart.

14. The computer-implemented method of claim 9 further comprising:
determining an average transaction amount associated with each respective merchant of the plurality of merchants located within the geographic region; and
displaying on the interactive graphical user interface the average transaction amount for each merchant relative to the other merchants of the plurality of merchants, wherein the number of transactions is represented as a barchart.

15. The computer-implemented method of claim 9 further comprising:
receiving a user definition associated with the user computing device; and
determining data to be displayed on the graphical user interface based on the user definition.

16. The computer-implemented method of claim 9 further comprising:
identifying at least one merchant of the plurality of merchants as a most underrepresented merchant; and
transmitting a report of the at least one most underrepresented merchant to the user computing device.

17. At least one non-transitory computer-readable storage medium having computer-executable instructions embodied thereon, wherein when executed by a representation analytics (RA) computing device including at least one processor in communication with a memory, the computer-executable instructions cause the at least one processor to:
receive transaction data associated with a plurality of transactions initiated by cardholders at a plurality of merchants located within a geographic region, the transaction data including a merchant identifier and an account identifier associated with a respective cardholder for each transaction of the plurality of transactions;
determine, using the account identifiers, a home location associated with each transaction of the plurality of transactions;
determine, using the merchant identifiers, a merchant location for the respective merchant associated with each transaction of the plurality of transactions;
determine a transaction travel distance for each transaction of the plurality of transactions, the transaction travel distance defined between the home location associated with the respective transaction and the merchant location of the merchant associated with the respective transaction;
determine an average transaction travel distance for each merchant of the plurality of merchants located with the geographic region;
display on an interactive graphical user interface of a user computing device the average transaction travel distance for each merchant within the geographic region.

18. The non-transitory computer-readable storage medium of claim 17, wherein the average transaction travel distance is graphically represented on a map of the geographic region.

19. The non-transitory computer-readable storage medium of claim 17, wherein the computer-executable instructions further cause the at least one processor to receive user input of a selection of the geographic region for which to display the average transaction travel distance.

20. The non-transitory computer-readable storage medium of claim 17, wherein the computer-executable instructions further cause the at least one processor to:
determine a merchant category of a plurality of merchant categories associated with each respective merchant of the plurality of merchants;
determine an average transaction travel distance for each merchant category of the plurality of merchant categories using the average transaction travel distance for each merchant within each merchant category of the plurality of merchant categories; and
display on the interactive graphical user interface the average transaction travel distance for each merchant category.

21. The non-transitory computer-readable storage medium of claim 17, wherein the computer-executable instructions further cause the at least one processor to:
determine a number of transactions initiated at each respective merchant of the plurality of merchants located within the geographic region; and
display on the interactive graphical user interface the number of transactions for each merchant relative to the other merchants of the plurality of merchants, wherein the number of transactions is represented as a barchart.

22. The non-transitory computer-readable storage medium of claim 17, wherein the computer-executable instructions further cause the at least one processor to:
determine an average transaction amount associated with each respective merchant of the plurality of merchants located within the geographic region; and
display on the interactive graphical user interface the average transaction amount for each merchant relative to the other merchants of the plurality of merchants, wherein the number of transactions is represented as a barchart.

23. The non-transitory computer-readable storage medium of claim 17, wherein the computer-executable instructions further cause the at least one processor to:
identify at least one merchant of the plurality of merchants as a most underrepresented merchant; and
transmit a report of the at least one most underrepresented merchant to the user computing device.
